(19) United States
(12) Patent Application Publication
(10) Pub. No.: US 2005/0008467 A1
(43) Pub. Date: Jan. 13, 2005

(54) Load port transfer device

(76) Inventors: Rich Huang, Miaoli (TW); Woodrow Jiang, Taichung (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/618,498

(22) Filed: Jul. 11, 2003

(51) Int. Cl. B66F 1/00

(52) U.S. Cl. 414/626

(57) ABSTRACT

A load port transfer device. The device, for delivering a wafer carrier along an overhead conveying system, includes a load port, a path, and a robot. The path has vertical and horizontal components. The vertical component has a top portion connected to the horizontal component and disposed beside the overhead conveying system and a bottom portion extending from the load port. The robot is movably disposed on the path to transfer the wafer carrier between the load port and the overhead conveying system.

### BACKGROUND OF THE INVENTION

1. Field of the Invention

The present invention relates to a load port transfer device, and more particularly to a load port with an extended path to provide high transfer capacity, continuous transfer, and prevent overloading without extra elements such as cable or buffer.

2. Description of the Related Art

High semiconductor demand currently requires manufacturers to increase plant and equipment asset investment. High wafer transport capacity between equipment and low fabrication costs help to maximize productivity and minimize time expenditures. One current apparatus for transferring wafers is an overhead hoist transfer (hereinafter “OHT”). For example, U.S. Pat. No. 6,460,711 to Kato, et al. discloses a suspension type hoist apparatus, elevatably suspended from a base via a suspension member (such as a cable) and adjusted by a positioning member in a horizontal plane. As shown in FIG. 1, a conventional transfer apparatus 10 has a carriage 103 moving along a rail 102 disposed on the ceiling 101, a suspension member 104 suspended from the carriage 102 and an elevating portion 105 attached to the lower end of the suspension member 104. However, as disclosed in the Kato patent, the elevating portion 105 is suspended by the suspension member 104, and the elevating portion 105 constitutes a pendulum, using the carriage 103 as a fulcrum. Thus, sway occurs at the elevating portion 105, resulting in positional deviation. In addition, the transfer apparatus disclosed by the Kato patent has another problem of alignment between the hand 105a and the base since the load 106 is mainly borne by the suspension member 104. As a result, additional components such as a position sensor 3 and a position actuator 1 attached to an upper plate 2 are necessary to prevent oscillation and misalignment. Realignment or configuration is required when obstacles pass and stop the transfer device. Thus, the conventional transfer device using the suspension member 104 must frequently stop, reducing transfer efficiency, and extra components also increase manufacturing costs.

Moreover, other solutions are provided by U.S. Pat. No. 6,504,144 to Murata (Overhead-traveling carrying apparatus) and U.S. Pat. No. 6,092,678 to Kawano, et al. (Overhead hoist transfer). As mentioned before, the OHT equipment uses a linear motor technology to transport wafer carriers 2 between the stocker 7A and manufacturing equipment 7, and in this case same as the Kato patent, both horizontal and vertical transport are combined, as shown in FIG. 2. Vertical transport must be completed before horizontal transport. The hoist mechanism, including a hand 5 performs vertical lift via a suspended part 4 (in Y-direction) and handles wafers 2 by a top flange (mushroom) of the Front Opening Unified Pod (FOUP) 8, usually a combination wafer cassette and transport carrier. The OHT runs on the ceiling, on which a carriage 3 is disposed, of which the carriage 3 comprises a traveling part 3a to move the hoist mechanism horizontally. The OHT is current widely used as a transfer device for loading or uploading 300 mm wafer carriers from an Automatic Material Handling System (AMHS) to process tool load ports. However, the suspended part 4 handling the wafer carriers 6 is also sensitive to airflow or other influence and its movement speed is slow, in consideration of safety concerns. As a result, the above patents both require sensor detection of obstacles such as operators or misplaced objects, any of which can cause transfer interruption. Furthermore, slow loading or uploading in vertical direction by the suspended part further results in traffic blocks in the horizontal direction, such that transfer efficiency is much lower than desired.

Hence, problems of low capacity, low speed, frequent stops, and alignment remain unsolved. Thus, there is a need for a transfer device that reduces factory costs and increases transfer efficiency, productivity, and yield.

### SUMMARY OF THE INVENTION

Accordingly, an object of the present invention is to provide a load port transfer device with a simple design.

Another object of the invention is to provide a load port transfer device that separates vertical and horizontal transport to maximize the flow capacity with a high degree of flexibility in operation.

Another object of the present invention is to provide a load port transfer device that maximizes transfer efficiency and yield rate.

The present invention relates to a low cost, high performance system to transfer wafer carriers between a load port and a conveyor.

Accordingly, the present invention provides a load port transfer device for delivering a wafer carrier by way of an overhead conveying system including a load port, a path, and a robot. The path has vertical and horizontal components. The vertical component has a top portion connected to the horizontal component and disposed beside the overhead conveying system and a bottom portion extending from the load port. The robot is movably disposed on the path to transfer the wafer carrier between the load port and the overhead conveying system.

Furthermore, the path is L-shaped, and the horizontal component is located above the overhead conveying system.

Accordingly, the robot further includes a moving mechanism, disposed within the path and a holding mechanism, disposed on the moving mechanism to maintain the wafer carrier's horizontal position.

Accordingly, the holding mechanism has first and second ends. The first end is removably connected to the wafer carrier and the second end is movably connected to the moving mechanism. The first end is gripper-shaped to grasp the wafer carrier.

Accordingly, the moving mechanism is a roller, a gear wheel, a chain, a timing belt, a curtain slat or a wire.

In another aspect of the present invention, a load port transfer device for delivering a wafer carrier to a conveying system comprises a load port, a path, and a robot. The path has vertical and horizontal components. The vertical component has a top portion beside the overhead conveying system and a bottom portion extending from the load port. The robot includes a moving mechanism and a holding mechanism. The moving mechanism is movably disposed on the path to transfer the wafer carrier between the load port and the overhead conveying system, and the holding mechanism has a first end holding the wafer carrier and a second end disposed on the moving mechanism.

Furthermore, the horizontal and the vertical components form an L-shape. The first end of the holding mechanism is gripper-shaped to grasp the wafer carrier

Accordingly, the moving mechanism is a roller, a gear wheel, a chain, a timing belt, a curtain slat or a wire.

According to one aspect of the present invention, an intra-bay delivery system comprises a wafer carrier, a load port, a conveyor, a rail, and a robot. The load port supports the wafer carrier. The conveyor is disposed above the load port. The rail has vertical and horizontal components. The vertical component extends from the load port and the horizontal component is located above the conveyor. The robot includes a roller and a holding portion. The roller is movably disposed on the rail to transfer the wafer carrier between the load port and the conveyor. The holding portion has a first end holding the wafer carrier and a second end disposed on the roller. The first end holding the wafer carrier is a flange.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a front view of a conventional transfer apparatus as referenced in U.S. Pat. No. 6,460,711;

FIG. 2 is a schematic view of a conventional overhead-traveling carrying apparatus as referenced in U.S. Pat. No. 6,504,144;

FIG. 3 is a perspective schematic view of the load port transfer device of the invention;

FIG. 4 is a schematic side view of the load port transfer device of the invention;

FIG. 5A is an enlarged view of an example of the robot of FIG. 4;

FIG. 5B is an enlarged view of another example of the robot of FIG. 4; and

FIG. 5C is an enlarged view of still another example of the robot of FIG. 4.

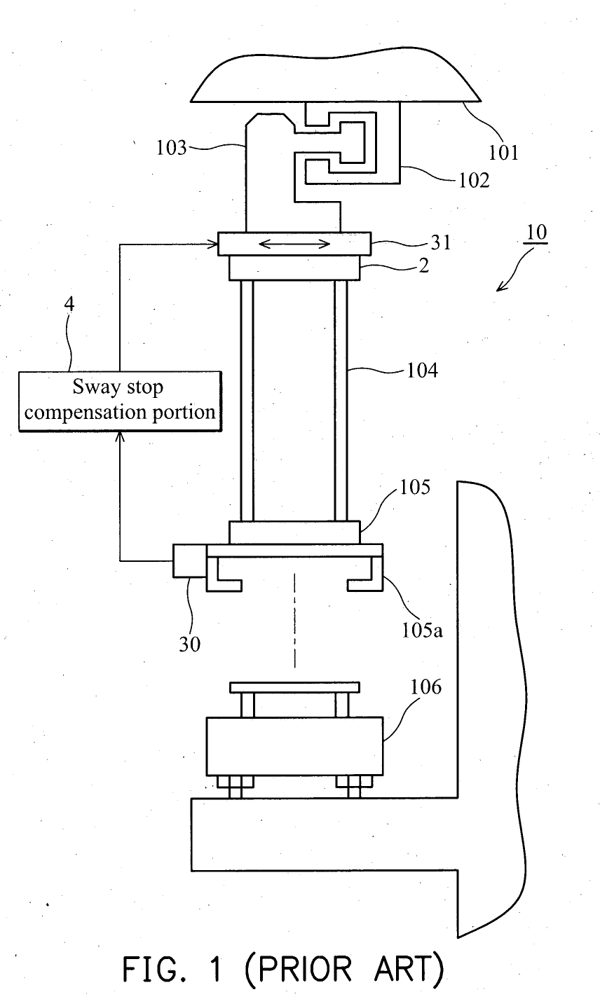

### DETAILED DESCRIPTION OF THE INVENTION

To maximize flow capacity, transfer efficiency, and yield rate, vertical and horizontal wafer transport must be separated so that they do not block each other. A load port transfer device is provided with a simple design at low manufacturing cost with a high degree of flexibility in operation and is described as follows.

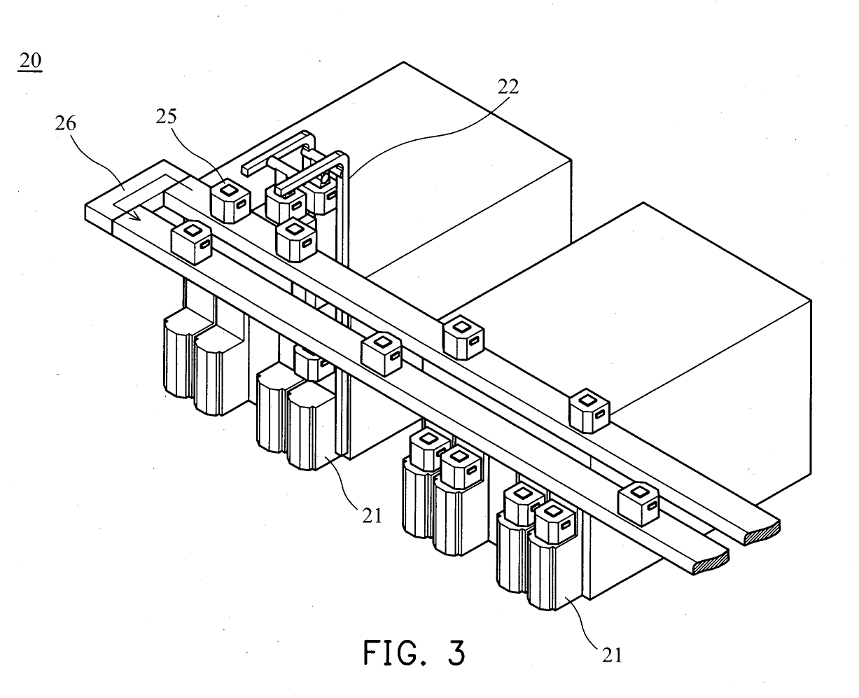

FIG. 3 is a perspective schematic diagram showing a load port transfer device 20 according to the present invention. The load port transfer device 20 acts as an intra-bay delivery system between manufacturing equipment, including other devices such as a wafer carrier 25, a conveyor 26, a load port 21, a rail (or path) 22, and a robot (not shown).

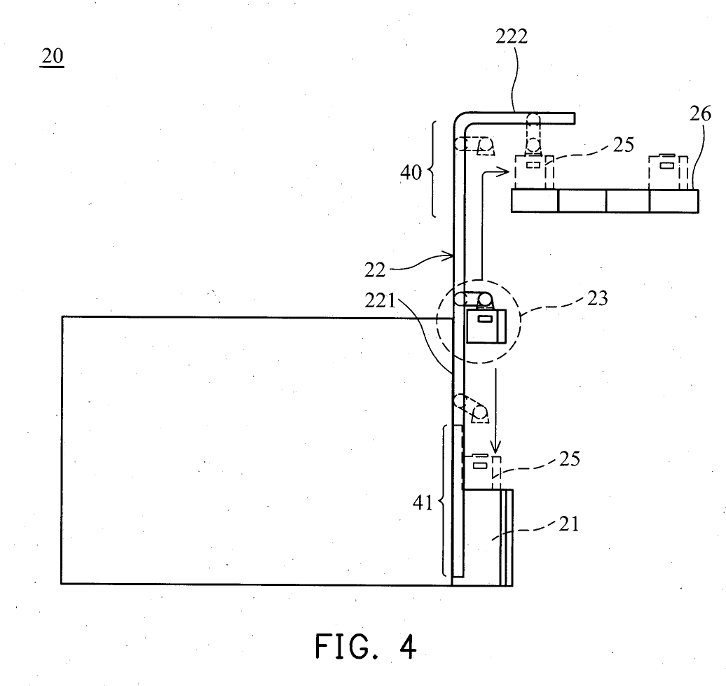

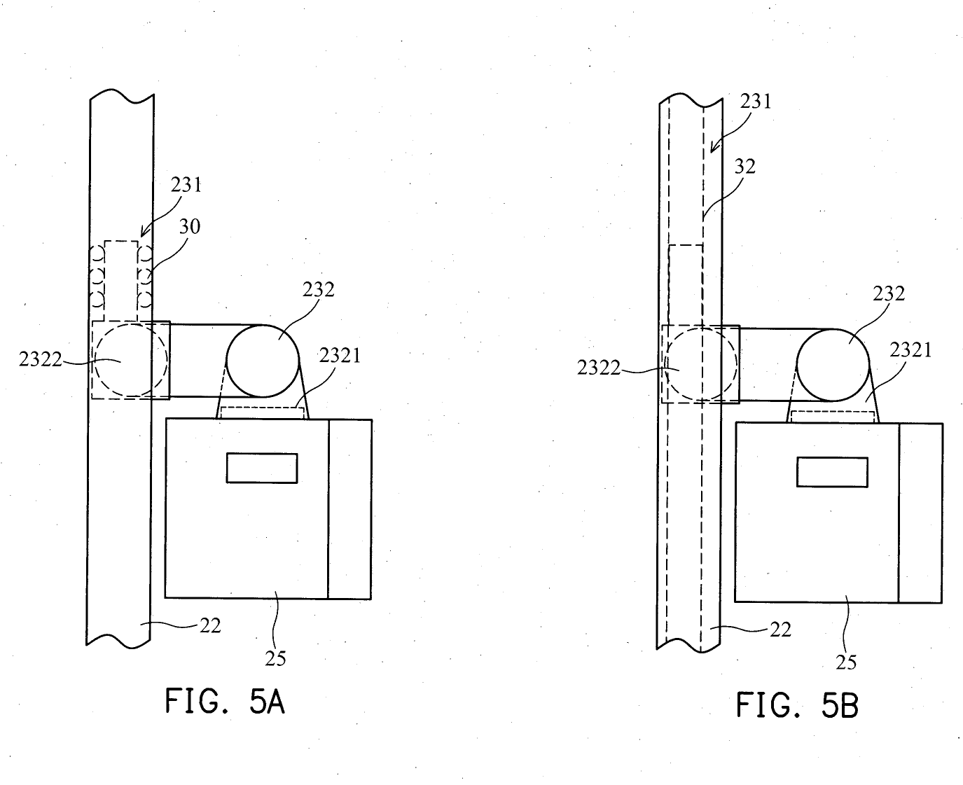

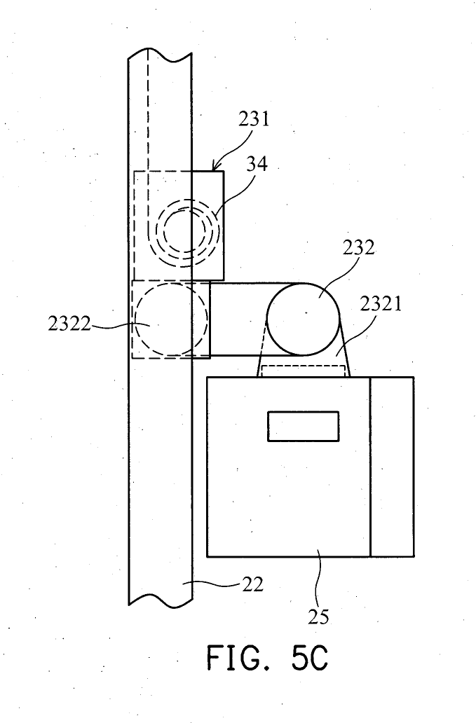

Only one rail 22 is depicted in the leftmost portion of FIG. 3 for clarity. In practice, each load port 21 is respectively disposed with a rail 22 thereon. Before transferring wafers from bottom to top, the load port 21 supports the wafer carrier 25 to load the wafers. The conveyor 26 is disposed above the load port 21 to receive the wafer carrier 25 for further horizontal transfer to other equipment. The load port transfer device 20 delivers the wafer carrier 25 along the overhead conveyor. As shown in FIG. 4, the rail 22 is L-shaped and has a vertical component 221 and a horizontal component 222. That is, the vertical and the horizontal components 221, 222 are connected to each other and may be integrated into one rail 22. The vertical component 221 extends from the load port 21 and the horizontal component 222 is located above the conveyor 26. More detail of a load port transfer device 20 is shown in FIGS. 4, 5A, 5B, and 5C. FIG. 4 shows the relative locations of the devices, in which the vertical component 221 has a top portion 40 beside the conveyor 26 and a bottom portion 41 extending from the load port 21. FIG. 5A, 5B, and 5C show various embodiments of the robot 23. The robot 23 is movably disposed on the rail 22 to transfer the wafer carrier 25 between the load port 21 and the conveyor 26. The robot 23 includes a moving mechanism 231 and a holding portion 232. The holding mechanism 232 is disposed on the moving mechanism 231 to maintain the wafer carrier 25's horizontal position.

In a first embodiment of the present invention, the moving mechanism 231 is a roller 30 or a gear wheel, as shown in FIG. 5A. The roller 30 is movably disposed on the rail 22 to vertically transfer the wafer carrier 25 between the load port 21 and the conveyor 26.

The holding portion 232 has a first end 2321 to hold the wafer carrier 25 and the first end 2321 is removably connected to the wafer carrier 25. The first end 2321 holding the wafer carrier 25 is a flange and the wafer carrier 25 is usually a Front Opening Unified Pod (FOUP). The first end 2321 is also gripper-shaped to grasp the wafer carrier 25. Thus, to load FOUP, the robot 23 grips the FOUP by the first end 2321. The holding portion 232 further has a second end 2322 disposed on the roller 30 and movably or rotatably connected the roller 30, as shown in FIG. 5A, so that the second end 2322 can rotate with respect to the roller 30 at the intersection of the vertical component 222 and horizontal component 221 on the rail 22. When the robot 23 turns along the rail 22 from the vertical component 222 to the horizontal component 221, the second end 2322 is located above the first end 2321 so that the wafer carrier 25 is disposed above the conveyor 26. The FOUP then is released from the first end 2321.

The moving mechanism 231 of a second embodiment is a chain, or a timing belt 32, as shown in FIG. 5B. With the exception of the moving mechanism, all other elements are the same as the first embodiment. The holding portion 232 has a first end 2321 to hold the wafer carrier 25 and the first end 2321 is removably connected to the wafer carrier 25. The first end 2321 holding the wafer carrier 25 is a flange and the wafer carrier 25 is usually a Front Opening Unified Pod (FOUP). The first end 2321 is also gripper-shaped to grasp the wafer carrier 25. The holding portion 232 further has a second end 2322 movably or rotatably connected to the chain, or the timing belt 32, as shown in FIG. 5B, so that the second end 2322 can rotate at the intersection of the vertical component 222 and horizontal component 221 on the rail 22. When the robot 23 turns along the rail 22 from vertical component 222 to the horizontal component 221, the second end 2322 is located above the first end 2321 so that the wafer carrier 25 is disposed on the conveyor 26. When the wafer carrier 25 is delivered to the conveyor 26 by the chain 32, the first end 2321 releases the wafer carrier 25 to the conveyor 26.

In the third embodiment, the moving mechanism 231 is a curtain slat or a wire 34, as shown in FIG. 5C. With the exception of the moving mechanism, all other elements are the same as the first embodiment. The holding portion 232 has a first end 2321 to hold the wafer carrier 25 and the first end 2321 is removably connected to the wafer carrier 25. The first end 2321 holding the wafer carrier 25 is a flange and the wafer carrier 25 is usually a Front Opening Unified Pod (FOUP). The first end 2321 is also gripper-shaped to grasp the wafer carrier 25. The holding portion 232 further has a second end 2322 movably or rotatably connected to the curtain slat or the wire 34, as shown in FIG. 5C, so that the second end 2322 can rotate at the intersection of the vertical component 222 and horizontal component 221 on the rail 22. When the robot 23 turns along the rail 22 from vertical component 222 to the horizontal component 221, the second end 2322 is located above the first end 2321 so that the wafer carrier 25 is disposed on the conveyor 26. When the wafer carrier 25 is delivered to the conveyor 26 by the chain 32, the first end 2321 releases the wafer carrier 25 to the conveyor 26.

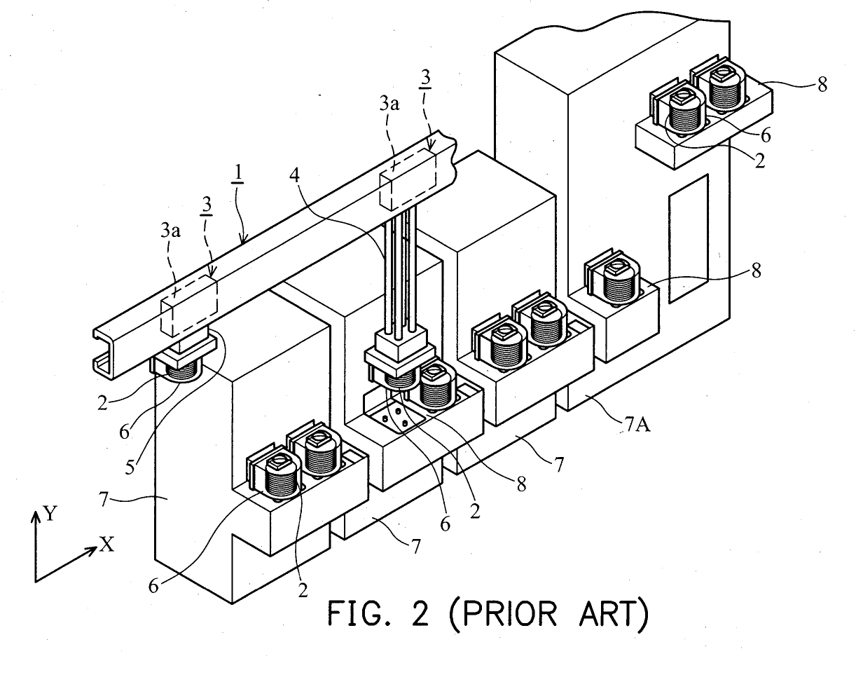

In comparison with the conventional transfer system shown in FIG. 2, the present invention does not require a suspension member 4 from the above OHT 1. During loading or unloading, unlike the conventional transfer system whose slow loading or uploading speed in the vertical direction via the suspended part causes traffic blocks in the horizontal direction, in the present invention, wafer carriers are horizontally movable on the conveyor 26, when vertical transfers along the rail 22 do not interfere with horizontal transfers on the conveyor 26. Also, transfer via the rail 22 is much faster and more stable than the suspension member 4. As a result, the problem of vertical transfer delay at the horizontal and vertical intersection is resolved accordingly, and transfer capacity is greatly increased.

Hence, the load port transfer device has the advantages of increased transport volume of the entire Automatic Material Handling System (AMHS), horizontal traffic is not blocked when loading or unloading FOUP, load/unload cycle time is greatly reduced, system reliability is improved, and the components and design of the load port transfer device are simpler than the conventional OHT.

When the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A load port transfer device, for delivering a wafer carrier along an overhead conveying system, including:
a load port;
a path, having vertical and horizontal components, the vertical component having a top portion connected to the horizontal component beside the overhead conveying system and a bottom portion extending from the load port; and
a robot, movably disposed on the path to transfer the wafer carrier between the load port and the overhead conveying system.

2. The load port transfer device as claimed in claim 1, wherein the path is L-shaped.

3. The load port transfer device as claimed in claim 1, wherein the horizontal component is located above the overhead conveying system.

4. The load port transfer device as claimed in claim 1, wherein the robot further includes a moving mechanism, disposed within the path and a holding mechanism, disposed on the moving mechanism to maintain the wafer carrier in a horizontal position.

5. The load port transfer device as claimed in claim 4, wherein the holding mechanism having first and second ends, wherein the first end is removably connected to the wafer carrier and the second end is movably connected to the moving mechanism.

6. The load port transfer device as claimed in claim 5, wherein the first end is gripper-shaped to grasp the wafer carrier.

7. The load port transfer device as claimed in claim 4, wherein the moving mechanism is a roller.

8. The load port transfer device as claimed in claim 4, wherein the moving mechanism is a gear wheel.

9. The load port transfer device as claimed in claim 4, wherein the moving mechanism is a chain.

10. The load port transfer device as claimed in claim 4, wherein the moving mechanism is a timing belt.

11. The load port transfer device as claimed in claim 4, wherein the moving mechanism is a curtain slat.

12. The load port transfer device as claimed in claim 4, wherein the moving mechanism is a wire.

13. A load port transfer device, for delivering a wafer carrier to a conveying system, comprising:
a load port;
a path, having vertical and horizontal components, the vertical component having a top portion beside the conveying system and a bottom portion, extending from the load port; and
a robot, including a moving mechanism movably disposed on the path to transfer the wafer carrier between the load port and the conveying system, and a holding mechanism having a first end holding the wafer carrier and a second end disposed on the moving mechanism.

14. The load port transfer device as claimed in claim 13, wherein the horizontal and the vertical components form an L-shape.

15. The load port transfer device as claimed in claim 13, wherein the first end is gripper-shaped to grasp the wafer carrier.

16. The load port transfer device as claimed in claim 13, wherein the moving mechanism is a roller.

17. The load port transfer device as claimed in claim 13, wherein the moving mechanism is a gear wheel.

18. The load port transfer device as claimed in claim 13, wherein the moving mechanism is a chain.

19. The load port transfer device as claimed in claim 13, wherein the moving mechanism is a timing belt.

20. The load port transfer device as claimed in claim 13, wherein the moving mechanism is a curtain slat.

21. The load port transfer device as claimed in claim 13, wherein the moving mechanism is a wire.

22. An intra-bay delivery system comprising:
a wafer carrier;
a load port supporting the wafer carrier;
a conveyor, disposed above the load port;
a rail having vertical and horizontal components, wherein the vertical component extends from the load port and the horizontal component is located above the conveyor; and
a robot including a roller movably disposed on the rail to transfer the wafer carrier between the load port and the conveyor and a holding portion having a first end holding the wafer carrier and a second end disposed on the roller, wherein the first end holding the wafer carrier is a flange.
